(19) United States
(12) Patent Application Publication
(10) Pub. No.: US 2026/0148409 A1
(43) Pub. Date: May 28, 2026

(54) INFORMATION PROCESSING SYSTEM FOR ESTIMATING POSITION-ORIENTATION OF CONTROLLER, HEAD-MOUNTED DISPLAY, CONTROLLER, AND METHOD OF CONTROLLING INFORMATION PROCESSING SYSTEM

(71) Applicant: CANON KABUSHIKI KAISHA, Tokyo (JP)

(72) Inventors: YU OKANO, Kanagawa (JP); NAOHITO NAKAMURA, Kanagawa (JP)

(21) Appl. No.: 19/003,209

(22) Filed: Dec. 27, 2024

Related U.S. Application Data
(63) Continuation of application No. PCT/JP2023/015064, filed on Apr. 13, 2023.

(30) Foreign Application Priority Data
Jul. 6, 2022 (JP) 2022-109047

(51) Int. Cl. G06T 7/73; G02B 27/01; G06T 7/579

(52) U.S. Cl. CPC G06T 7/73; G02B 27/0101; G02B 27/017; G06T 7/579; G02B 2027/0138; G06T 2207/30244

(57) ABSTRACT

An information processing system includes a head-mounted display and a controller, and configured to estimate a position-orientation of the controller, wherein the head-mounted display includes: a first camera; and one or more processors and/or circuitry configured to: acquire position-orientation information of the head-mounted display by using a captured image captured by the first camera; generate map information based on the position-orientation information of the head-mounted display and a keyframe image that is a captured image captured at that position-orientation; extract a part of the map information; and transmit extracted map information to the controller, and the controller includes: a second camera; and one or more processors and/or circuitry configured to acquire position-orientation information of the controller by using a captured image captured by the second camera and the extracted map information transmitted from the head-mounted display.

### CROSS-REFERENCE TO RELATED APPLICATIONS

This application is a Continuation of International Patent Application No. PCT/JP 2023/015064, filed Apr. 13, 2023, which claims the benefit of Japanese Patent Application No. 2022-109047, filed Jul. 6, 2022, both of which are hereby incorporated by reference herein in their entirety.

### BACKGROUND OF THE INVENTION

### Field of the Invention

The present invention relates to an information processing system for estimating the position-orientation of a controller, a head-mounted display, a controller, and a method of controlling the information processing system.

### Background Art

Recently, a technology for installing a terminal device in an image capturing device, and estimating the location of the terminal device and producing a map of the environment by using simultaneous localization and mapping (SLAM) has come to be used in various applications. For example, PTL 1 discloses an unmanned transport vehicle that is provided with a map updating function using the SLAM, and that is capable of driving autonomously, and moreover improves the accuracy of the autonomous driving by using the coordinate information of landmark images projected along a path.

Estimations of the position and the orientation of a controller (terminal device) of a device such as a head-mounted display (HMD) or a gaming machine can be improved by referring to a map created using the SLAM. However, because the processing capacity and storage capacity of such a controller are limited for the purpose of suppressing the enhancement of weight and size of controller, there are limitations to the estimation of position orientation by using the SLAM. Although the controller may also use odometry (dead reckoning) so as to estimate the position and orientation (position-orientation) of the controller, errors thereof accumulate. Therefore, it is difficult for the controller to estimate the position and orientation highly accurately, while reducing the processing load.

The present invention provides a technology enabling a terminal device, which has a limited processing capacity and storage capacity, to make favorable position-orientation estimations.

### CITATION LIST

### Patent Literature

PTL 1 Japanese Patent Application Laid-open No. 2022-093887

### Non-Patent Literature

NPL 1 Rainer Kummerle, et al., “g2o: A General Framework for Graph Optimization”, (online), May 9, 2011, 2011 IEEE International Conference on Robotics and Automation, Shanghai International Conference Center, (Searched on Jun. 27, 2022), Internet <URL:http://ais.informatik.uni-freiburg.de/publications/papers/kuemmerle11icra.pdf>

NPL 2 R. Mur-Artal, et al., “ORB-SLAM: A Versatile and Accurate Monocular SLAM System”, (online), Oct. 5, 2015□ IEEE Transactions on Robotics, vol. 31, no. 5, pp. 1147-1163□ (Searched on Jul. 5, 2022), Internet <URL:https://ieeexplore.ieee.org/document/7219438>

### SUMMARY OF THE INVENTION

An information processing system according to the present invention includes a head-mounted display and a controller, and is configured to estimate a position-orientation of the controller, wherein the head-mounted display includes: a first camera; and one or more processors and/or circuitry configured to: perform first acquiring processing to acquire position-orientation information of the head-mounted display by using a captured image captured by the first camera; perform generating processing to generate map information based on the position-orientation information of the head-mounted display and a keyframe image that is a captured image captured at that position-orientation; perform extracting processing to extract a part of the map information; and perform communicating processing to transmit extracted map information extracted in the extracting processing to the controller, and the controller includes: a second camera; and one or more processors and/or circuitry configured to perform second acquiring processing to acquire position-orientation information of the controller by using a captured image captured by the second camera and the extracted map information transmitted from the head-mounted display.

Further features of the present invention will become apparent from the following description of exemplary embodiments with reference to the attached drawings.

### BRIEF DESCRIPTION OF THE DRAWINGS

FIG. 1A is a block diagram illustrating an exemplary configuration of an HMD;

FIG. 1B is a block diagram illustrating an exemplary configuration of a controller;

FIG. 2 is a schematic for explaining an information processing system according to a first embodiment;

FIG. 3 is a schematic for explaining keyframe information;

FIG. 4 is a schematic for explaining a first method for extracting an extracted map;

FIG. 5 is a schematic for explaining a second method for extracting the extracted map;

FIG. 6 is a schematic for explaining a first example of a third method for extracting the extracted map;

FIG. 7 is a schematic for explaining the first example of the third method for extracting the extracted map;

FIG. 8 is a flowchart illustrating a second example of the third method for extracting the extracted map;

FIG. 9 is a schematic for explaining an information processing system according to a second embodiment; and

FIG. 10 is a schematic for explaining an information processing system according to a third embodiment.

### DESCRIPTION OF THE EMBODIMENTS

Some embodiments of the present invention will now be explained with reference to drawings. The embodiments described below only illustrate some examples of an implementation of the present invention, and may be corrected or modified as appropriate, depending on the configuration of the device to which the present invention is applied, or on various conditions. Furthermore, these embodiments may be combined as appropriate.

### First Embodiment

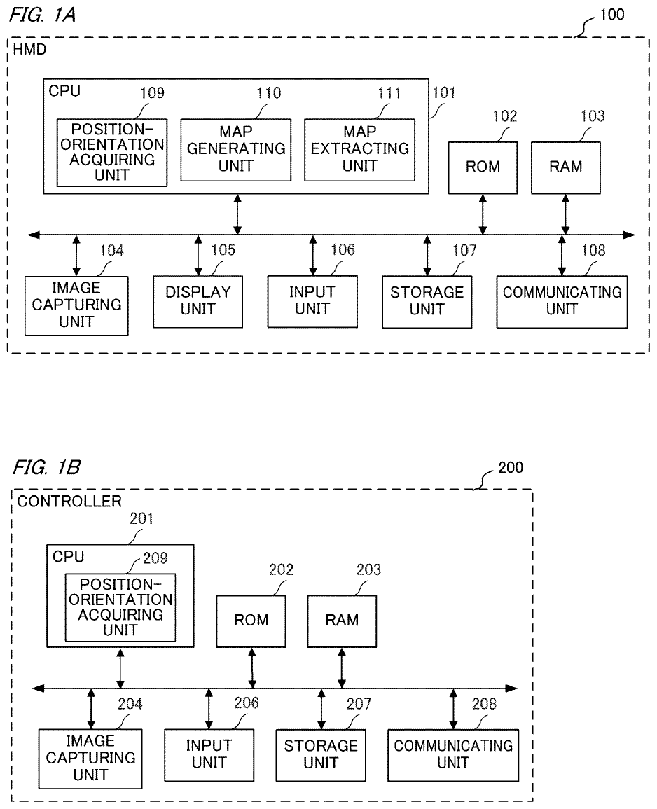

FIGS. 1A and 1B are block diagrams illustrating an exemplary configuration of an information processing system according to one embodiment of the present invention. The information processing system includes a head-mounted display (HMD) 100 that is an information processing apparatus, and a controller 200 that is terminal device.

The HMD 100 is an HMD adopting the video see-through system, and configured to create a composite of an image of the outer world (real space) and graphics (e.g., a virtual object), and to display the composite image, as required. The controller 200 is capable of manipulating the virtual object or the like to displayed on the HMD 100, for example.

FIG. 1A is a block diagram illustrating an exemplary configuration of the HMD 100. A CPU 101 reads control programs corresponding to respective blocks included in the HMD 100 from a ROM 102, loads the control programs onto a RAM 103, and executes the control programs. With this, the CPU 101 controls operations of the blocks included in the HMD 100. A part of the processing executed by the CPU 101 may be executed by a hardware circuit.

The ROM 102 is an electrically erasable and recordable non-volatile memory. The ROM 102 stores therein not only operation programs corresponding to the respective blocks included in the HMD 100, but also parameters and the like used by the blocks during their operations.

The RAM 103 is a rewritable volatile memory. The RAM 103 is used in loading a program to be executed by the CPU 101 or the like, for example, and for temporarily storing data generated by the operations of the blocks included in the HMD 100.

An image capturing unit 104 is a camera including elements such as an optical system (lenses), an image sensor such as a CCD or a CMOS sensor, and an A/D converter. The image capturing unit 104 applies photoelectric conversion of an optical image formed on the image plane by the optical system, and outputs the resultant analog image signal. The analog image signal is converted by the A/D converter into digital image data, and temporarily stored in the RAM 103.

A display unit 105 controls displaying of images captured by the image capturing unit 104 and other visual objects. An input unit 106 receives an operation from a user. A storage unit 107 (storage portion) is a memory that stores therein a captured image captured by the image capturing unit 104, an application program, and various types of data, such as data generated by the application program, for example.

A communicating unit 108 is an interface for communicating with an external device over the wire or wirelessly. The communicating unit 108 can communicate wirelessly with another device such as the controller 200, via a communication protocol such as Wi-Fi and/or Bluetooth (registered trademark) Low Energy (BLE).

The CPU 101 includes a position-orientation acquiring unit 109, a map generating unit 110, and a map extracting unit 111, as the functional blocks. The position-orientation acquiring unit 109 acquires position-orientation information of the HMD 100. The position-orientation acquiring unit 109 can acquire position-orientation information from a captured image captured by the image capturing unit 104, using the SLAM technology.

The map generating unit 110 generates map information, on the basis of the SLAM, the map information being used by the position-orientation acquiring unit 109 to acquire the position-orientation information of the HMD 100. The map generating unit 110 establishes mapping of keyframe images that are regularly captured, and information such as information of feature points included in the images and information of position-orientation of the HMD 100, and records the resultant mapping as map information, in the storage unit 107. The position-orientation acquiring unit 109 can estimate the information of position-orientation of the HMD 100 by creating and optimizing keyframes while keeping track of the feature points detected from the captured images, as appropriate, and by optimizing the position-orientation of the HMD 100 using the feature points in the map information that is a set of pieces of keyframe information, as disclosed in NPL 2.

The map extracting unit 111 extracts map information to be used in estimating a position-orientation of the controller 200, from the map information of the HMD 100, generated by the map generating unit 110. The extracted map information will also be referred to as extracted map information. The extracted map information is transmitted to the controller 200. Because the extracted map information is generated by extracting a part of the map information of the HMD 100, the amount of data transmitted to the controller 200 as well as the processing load of the controller 200 are reduced.

FIG. 1B is a block diagram illustrating an exemplary configuration of the controller 200. The CPU 201 reads control programs corresponding to respective blocks included in the controller 200 from the ROM 202, loads the control programs onto a RAM 203, and executes the control programs. With this, the CPU 201 controls operations of the blocks included in the controller 200. A part of the processing executed by the CPU 201 may also be executed by a hardware circuit, for example.

The ROM 202 is an electrically erasable and recordable non-volatile memory. The ROM 202 stores therein operation program corresponding to the respective blocks included in the controller 200, but also parameters and the like used by the blocks in the operations.

The RAM 203 is a rewritable volatile memory. The RAM 203 is used in loading a program to be executed by the CPU 201 or the like, for example, and for temporarily storing data generated by the operations of the blocks included in the controller 200.

An image capturing unit 204 is a camera including elements such as an optical system, an image sensor such as a CCD or a CMOS sensor, and an A/D converter, in the same manner as the image capturing unit 104 of the HMD 100. The image capturing unit 204 may include a plurality of cameras. The image capturing unit 204 is a monochromatic monocular camera, for example.

An input unit 206 receives an operation from a user. A storage unit 207 (storage portion) is a memory that stores therein a captured image captured by the image capturing unit 204, an application program, and various types of data such as data generated by the application program, for example. A communicating unit 208 is an interface for communicating with an external device over the wire or wirelessly, and can communicate wirelessly with another device such as the HMD 100 via a communication protocol such as Wi-Fi and/or BLE.

The CPU 201 includes a position-orientation acquiring unit 209, as a functional block. The position-orientation acquiring unit 209 acquires position-orientation information of the controller 200. The position-orientation acquiring unit 209 acquires the position-orientation information of the controller 200, from a captured image captured by the image capturing unit 204. The controller 200 may also include an inertial measurement unit (IMU), not illustrated, and the position-orientation acquiring unit 209 may estimate the position-orientation of the controller 200 on the basis of an acceleration and an angular velocity measured by the IMU.

The position-orientation acquiring unit 209 may also acquire the position-orientation information of the controller 200 using a captured image captured by the image capturing unit 204 or odometry (dead reckoning) which uses the IMU, and acquire the position-orientation information using the extracted map information at a predetermined timing. In other words, at a predetermined timing, the position-orientation acquiring unit 209 acquires the position-orientation information of the controller 200, using a captured image captured by the image capturing unit 204 and the extracted map information extracted by the map extracting unit 111.

Examples of the predetermined timing include a regular timing and a fixed timing. The frequency at which position-orientation information of the controller 200 is acquired using the extracted map information may be determined on the basis of the processing capacity of the controller 200; that is, a lower frequency may be used for a less processing capacity. Furthermore, the predetermined timing may be a timing at which the position-orientation information acquired using the odometry has become less accurate, due to an increased speed or irregular movement of the controller 200.

In the position-orientation information acquired using the odometry, errors accumulate; however, by using a captured image captured by the image capturing unit 204 and the extracted map information, the position-orientation acquiring unit 209 can reduce the accumulated errors and to acquire the position-orientation information of the controller 200 more accurately.

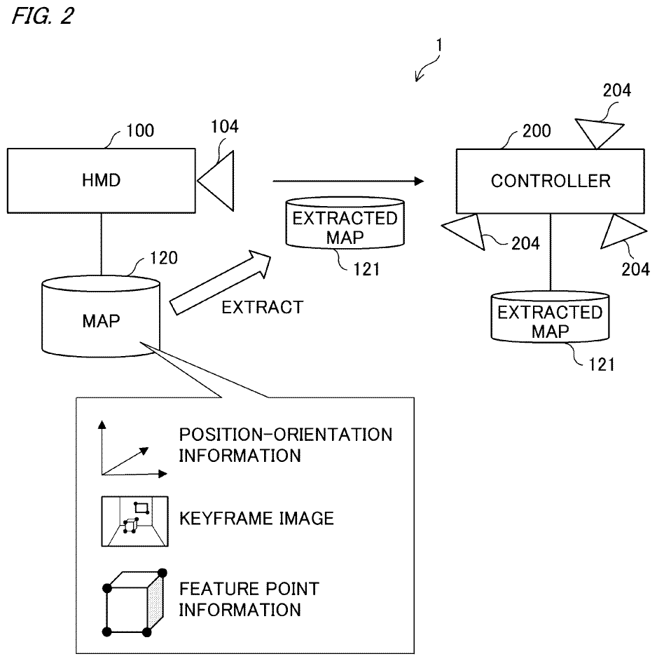

FIG. 2 is a schematic for explaining the information processing system according to the first embodiment. This information processing system 1 includes the HMD 100 and the controller 200. The position-orientation acquiring unit 109 included in the HMD 100 acquires position-orientation information of the HMD 100, using a captured image captured by the image capturing unit 104. The HMD 100 generates a map 120 (map information) on the basis of the position-orientation information of the HMD 100 and a keyframe image that is a captured image captured at that position-orientation. The map 120 includes information of feature points detected from the keyframe image. The HMD 100 generates an extracted map 121 (extracted map information) by extracting a part of the map 120. The generated extracted map 121 is transmitted to the controller 200.

The position-orientation acquiring unit 209 included in the controller 200 acquires the position-orientation information of the controller 200 using a captured image captured by the image capturing unit 204. A position-orientation acquiring unit 209 acquires, at a predetermined timing, the position-orientation information of the controller 200 using a captured image captured by the image capturing unit 204 and the extracted map 121 received from the HMD 100.

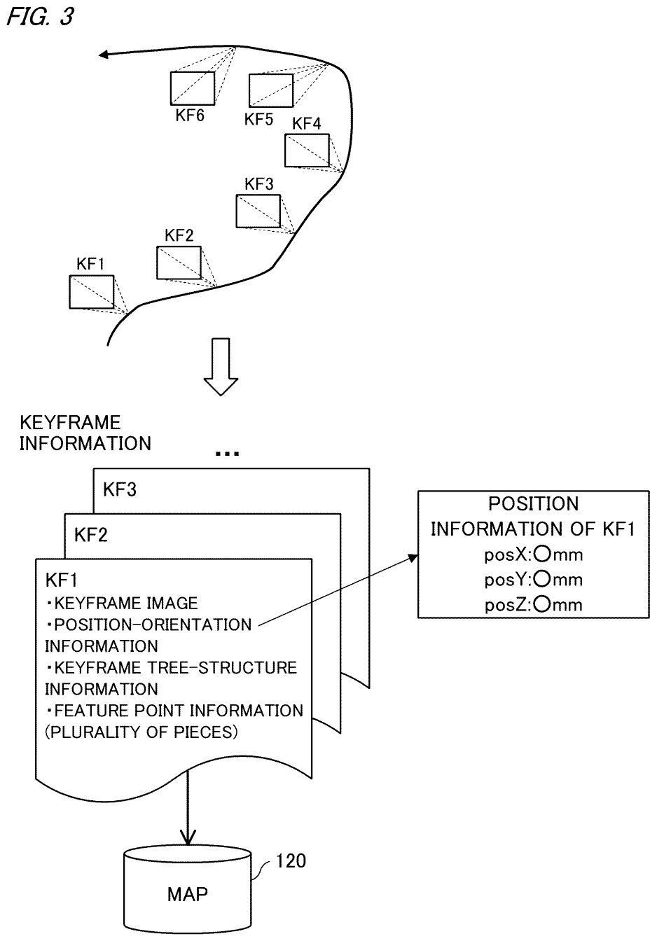

FIG. 3 is a schematic for explaining keyframe information. The example illustrated in FIG. 3 illustrates a distribution of keyframes KF1 to KF6 along a trajectory of the HMD 100. Each of such keyframes includes keyframe information that is a mapping of a piece of position-orientation information of the HMD 100 to a keyframe image captured at the position-orientation. The map 120 includes a plurality of pieces of keyframe information, but the pieces of keyframe information are illustrated only partly in FIG. 3, for the simplicity. The positions of the keyframes are indicated on a two-dimensional plane, but in reality, corresponds to positions in a three-dimensional space.

The keyframe information is created once in every predetermined time interval, or once in every predetermined distance of movement, for example. The predetermined time interval and the predetermined distance of movement may be determined depending on a speed the movement and the processing capacity of the HMD 100, for example. The created keyframe information is stored in the storage unit 107, as the map 120.

The keyframe information includes a keyframe image, position-orientation information, keyframe tree-structure information, and a plurality of pieces of feature point information. A keyframe image is an image captured by the image capturing unit 104 at the time when the keyframe information is created. A keyframe image may include information of the time and the date at and on which the keyframe image is created, as a piece of meta-information. The time and the date at and on which the keyframe image is created may also be retained as the keyframe information.

The position-orientation information is the position-orientation information of the HMD 100 at the time when the keyframe image is captured, and is represented in an XYZ coordinate system, for example. The keyframe tree-structure information is information indicating a relationship between keyframes, e.g., the order in which the keyframes are captured or a positional relationship between the keyframes. The feature point information is the position information of the feature points included in the keyframe image.

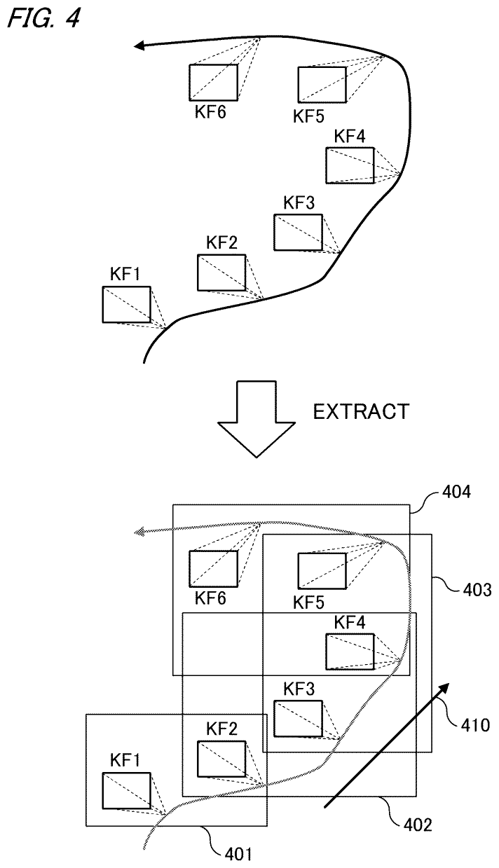

Explained now with reference to FIGS. 4 to 6 is a method in which the map extracting unit 111 of the HMD 100 generates an extracted map 121 by extracting keyframe information from the map 120.

(First Extraction Method) FIG. 4 is a schematic for explaining a first method for extracting an extracted map 121. The map extracting unit 111 extracts keyframe information having been created within a nearby area around the controller 200, from the map 120. In the example illustrated in FIG. 4, when a rectangle 401 is the area nearby the controller 200, the keyframe information of a keyframe KF1 and a keyframe KF2 is extracted as an extracted map 121, and is transmitted to the controller 200.

As the controller 200 moves in the direction of the arrow 410, the map extracting unit 111 generates an extracted map 121 by extracting keyframe information of keyframes KF2 to KF4 included in a rectangle 402. As the controller 200 moves, the nearby area shifts to a rectangle 403 and to a rectangle 404, and the keyframe information included in each of these rectangular areas is extracted as an extracted map 121. When the controller 200 moves for a predetermined time or by a predetermined distance, the map extracting unit 111 generates an extracted map 121, for example. The generated extracted map 121 is transmitted, by the communicating unit 108, to the controller 200.

A nearby area around the controller 200 may be set to as a cuboid or spherical area having the center at the position of the controller 200, for example. The position of the controller 200 is acquired from the controller 200, for example, before determining the nearby area. The size of the nearby area may be determined on the basis of the processing capacity of the CPU 201, the storage capacity of the storage unit 207, the number of pieces of keyframe information within the nearby area, for example.

The map extracting unit 111 included in the HMD 100 acquires the position of the controller 200, and determines the nearby area by detecting the controller 200 from a captured image captured by the image capturing unit 104, for example. The map extracting unit 111 may also determine the nearby area using position information received from the controller 200.

The transmission ratio at which the map extracting unit 111 extracts the map 120 and transmits to the controller 200 may be determined based on the processing capacity and the storage capacity of the controller 200. In other words, the map extracting unit 111 changes the amount or the ratio of the keyframe information to be extracted from the map 120, on the basis of at least one of the processing capacity and the storage capacity of the controller 200.

The map extracting unit 111 may also change the amount or the ratio of the keyframe information to be extracted from the map 120, on the basis of the speed of the movement of the controller 200. For example, when it is expected that the speed of the movement is to increase on the basis of information such as the type of application executed by the controller 200 and a history of the speed of the movement during the past usage, the HMD 100 preferably sets the amount of or the ratio to be extracted as the extracted map 121 high. In such a case, the amount or the ratio to be extracted as the extracted map 121 may be set in advance, on the basis of factors such as the type of applications.

Furthermore, the HMD 100 may also increase the amount to be extracted as the extracted map 121 at the timing at which the controller 200 makes a stop, to prepare for the next movement of the controller 200.

The map extracting unit 111 may also change the amount or the ratio of the keyframe information to be extracted from the map 120, on the basis of the acquisition conditions of the position-orientation information of the controller 200. For example, when the controller 200 becomes lost, with no position-orientation information being acquired, due to factors such as blurs in the captured image captured by the image capturing unit 204, the map extracting unit 111 may increase the amount or the ratio to be extracted.

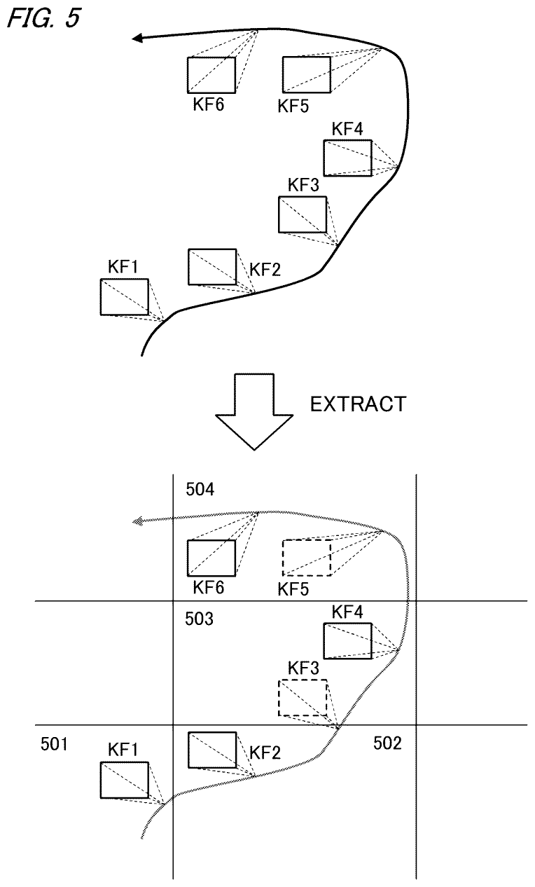

(Second Extraction Method) FIG. 5 is a schematic for explaining a second method of extracting an extracted map 121. The map extracting unit 111 generates an extracted map 121, by dividing the entire area (area of experience) including the distribution of keyframes (the positions where keyframe images are captured) into a plurality of split areas, and by extracting representative keyframe information from each of such split areas.

In the example in FIG. 5, the map extracting unit 111 selects a keyframe KF1, a keyframe KF2, a keyframe KF4, and a keyframe KF6 from respective split areas 501 to 504, and extract keyframe information therefrom. By extracting a representative piece of keyframe information from each split area, the map extracting unit 111 can reduce the amount of keyframe information to be extracted.

The map extracting unit 111 may select a representative piece of the keyframe information from each split area, on the basis of qualities of a plurality of respective pieces of keyframe information. Examples of the quality of a piece of keyframe information includes the amount by which the keyframe position is corrected during the keyframe optimization process (see NPL 1), the number of feature points included in the keyframe image (when there is a subsequent process for removing the feature points, the number of remaining feature points), the ratio by which the keyframe image is occupied by blur, the number of moving objects included in the keyframe image, or the timing at which the piece of keyframe information is generated. The map extracting unit 111 may select the keyframe information having the keyframe position corrected by a less amount, the keyframe information the keyframe image of which has a larger number of feature points linked thereto, the keyframe information including less blur, the keyframe information with a less number of moving objects, or the keyframe information generated on a later time and date, from the pieces of keyframe information inside the split area.

The number of and the size of the split areas may be changed on the basis of the size of the entire area including the distribution of the keyframes (area of experience). If the area of experience is larger, and therefore the number of split areas is greater, the amount of the keyframe information to be extracted also becomes increased. In such a case, the map extracting unit 111 may reduce the number of split areas by dividing the entire area into larger split areas and thus increasing the size of split areas. The map extracting unit 111 may be configured to, when the number and the size of the split areas are changed, generate an extracted map 121, and to transmit the generated extracted map 121 to the controller 200 via the communicating unit 108.

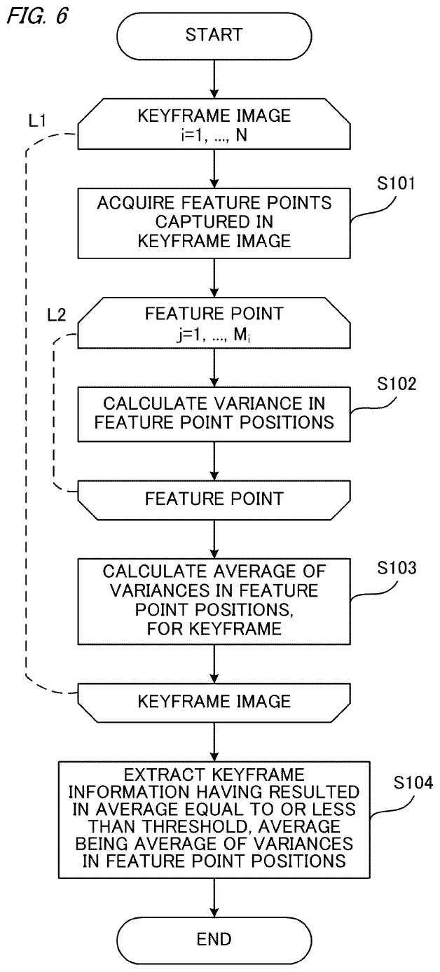

(Third Extraction Method) A third method of extracting an extracted map 121 will now be explained with reference to FIGS. 6 to 8. The map extracting unit 111 extracts keyframe information on the basis of a variance in the positions of the feature points included in the keyframe images, or feature point reprojection errors.

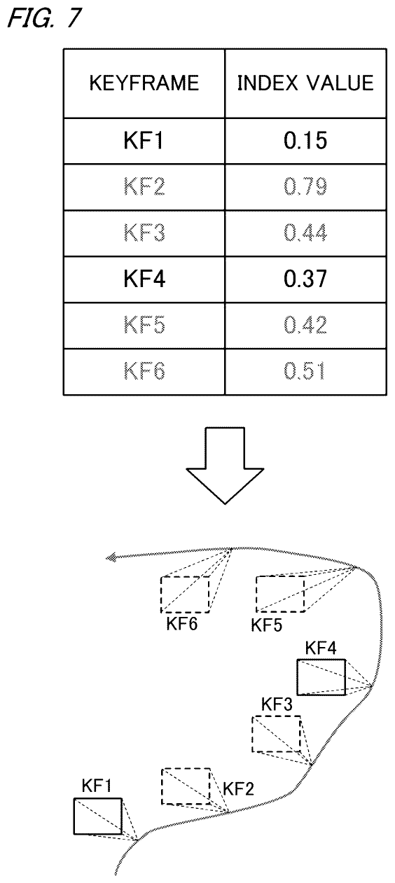

FIGS. 6 and 7 are schematics for explaining a first example of the third extraction method for extracting the keyframe information on the basis of variance in the positions of the feature points included in the keyframe image. A plurality of feature points are included in the keyframe image, and, in the first example, the map extracting unit 111 calculates a variance in the positions of each of the feature points included in the keyframe image. The map extracting unit 111 may use an average variance in the feature points, as an index value for extracting the keyframe information, for example. The map extracting unit 111 extracts the keyframe image with a smaller average variance in the positions of the feature points included in the keyframe image, at a higher priority. FIG. 6 is a flowchart for explaining a first example of a method for calculating an index value, as a measurement of the quality of each of the individual keyframes, for the purpose of extracting the keyframe information.

The map extracting unit 111 executes Process L1 for calculating an average variance in the positions of feature points included in a keyframe image i, for all of the keyframe images i included in the map 120 (in the example illustrated in FIG. 6, i−1, . . . , N, where N is a natural number).

At Step S101 of Process L1, the map extracting unit 111 acquires information of feature points included in the keyframe image i. At this time, the information of the feature points is information before an optimization process such as that disclosed in NPL 1 is applied, and includes a depth value of each feature point observed from the keyframe and information of the coordinates of the feature point in the image. Even the same feature point exhibits slightly different three-dimensional positions depending on the keyframe from which the feature point is observed.

The map extracting unit 111 then executes Process L2 for calculating the variance in the positions of a feature point j, for all of the feature points j included in the keyframe images i (in the example illustrated in FIG. 6, where j−1, . . . , Mᵢ, where Mᵢ is a natural number that is different for each of the keyframe images i).

At Step S102 of Process L2, the map extracting unit 111 calculates the variances in the positions of the feature point j. After calculating the variances in the positions of all of the feature points j included in the keyframe image i (where j=1, . . . , Mᵢ), the map extracting unit 111 goes to Step S103.

At Step S103 of Process L1, the map extracting unit 111 calculates, for the keyframe image i, an average of the variances in the positions of the respective feature points j, the variances being obtained at Step S102, as an index value. The method for calculating the index value may be any method as long as one index value can be obtained from the variance in the positions of the respective feature points j, without necessarily being limited to the method of calculating the average. As the method for calculating the index value, various calculations may be used, including, for example, a method of calculating a median or a weighted average, as well as a method for calculating a simple arithmetic average.

After calculating the average of the variances in the positions of the feature points, for all of the keyframe images i (i=1, . . . , N) included in the map 120, the map extracting unit 111 goes to Step S104. At Step S104, the map extracting unit 111 extracts the keyframe information having resulted in the average of not more than a threshold, the average being the average of the variances in the feature point positions calculated at Step S103. The extracted keyframe information is transmitted, by the communicating unit 108, to the controller 200.

In the example illustrated in FIG. 7, the map extracting unit 111 extracts the keyframe information of the keyframe KF1 and the keyframe KF4, each having an average less than 0.40, the average being an average of the variance in the feature point positions, calculated as an index value. In the manner described above, the map extracting unit 111 may set a threshold, and extract keyframe information with a variance less than the threshold, or may extract the number of pieces of keyframe information corresponding to a predetermined ratio, from those with a less variance.

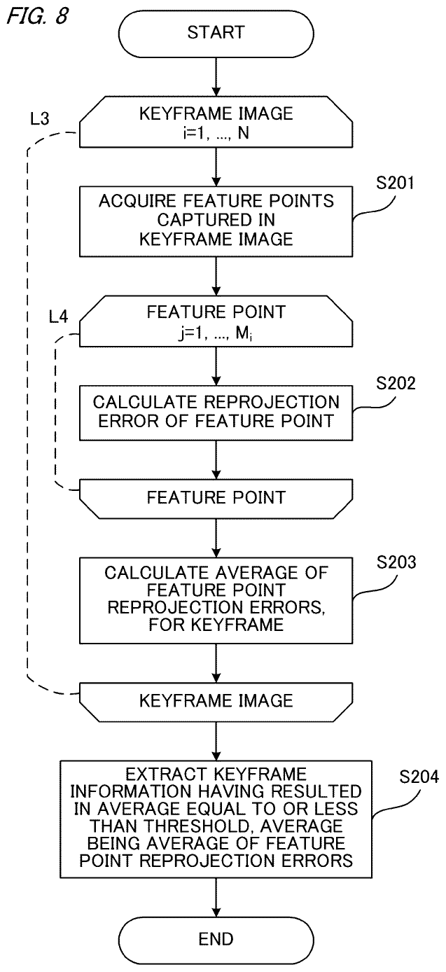

FIG. 8 is a schematic for explaining a second example of the third extraction method for extracting the keyframe information, on the basis of reprojection errors in the feature points included in the keyframe image. The map extracting unit 111 extracts a piece of keyframe image with small reprojection errors of the feature points, at a higher priority. FIG. 8 is a flowchart for explaining a second example of the method for calculating an index value as a measurement of the quality of each of the individual keyframes, for the purpose of extracting the keyframe information.

The map extracting unit 111 executes Process L3 for calculating an average of the reprojection errors in the feature points of a keyframe image i, for all of the keyframe images i included in the map 120 (in the example illustrated in FIG. 8, i−1, . . . , N, where N is a natural number). The process at Step S201 of Process L3 is the same as that of Step S101 in FIG. 6.

The map extracting unit 111 then executes Process L4 for calculating a reprojection error of a feature point j, for all of the feature points j included in the keyframe image i (in the example illustrated in FIG. 8, where j−1, . . . , Mᵢ, where Mᵢ is a natural number that is different for each of the keyframe images i).

At Step S202 of Process L4, the map extracting unit 111 calculates the reprojection error of a feature point j. Assuming that a projection surface is set a distance of 1 meter, for example, and that a feature point included in the map is reprojected onto the projection surface on the basis of the position-orientation of the HMD 100, the position-orientation being acquired by the position-orientation acquiring unit 109, a reprojection error is a difference between the image coordinates of the feature point perceived at the current position-orientation, and the two-dimensional coordinates of the feature point reprojected onto the projection surface. When the reprojection error has been calculated for all of the feature points j included in the keyframe image i (j=1, . . . , Mᵢ), the map extracting unit 111 goes to Step S203.

At Step S203 of Process L3, the map extracting unit 111 calculates, for the keyframe image i, an average of the reprojection errors of the feature points j obtained at Step S202, as an index value. The method for calculating an index value is not limited to that for calculating an average, as long as one index value is obtained. As the method for calculating the index value, various calculations may be used, including, for example, a method of calculating a median or a weighted average, as well as a method for calculating a simple arithmetic average.

If the average of the reprojection errors of the feature points has been calculated for all of the keyframe images i (i=1, . . . , N) included in the map 120, the map extracting unit 111 goes to Step S204. At Step S204, the map extracting unit 111 extracts the keyframe information having resulted in the average of not more than a threshold, the average being an average of the reprojection errors of the feature points, calculated at Step S203. The extracted keyframe information is then transmitted, by the communicating unit 108, to the controller 200.

The map extracting unit 111 may be configured to extract keyframe information on the basis of various types of index value representing the quality of a keyframe, without limitation to the variance in the positions of the feature points and the reprojection errors in the feature points included in the keyframe image.

(Other Extraction Methods) In addition to the first to the third extraction methods described above, it is possible to generate an extracted map 121 from the map 120 on the basis of the quality of the keyframe information, in the same manner as the example in which representative keyframe information is selected from a split area in the second extraction method. Examples of the quality of the keyframe information include the amount by which the keyframe positions are corrected during the keyframe optimization process (see NPL 1), the number of feature points included in the keyframe image (the number of remaining feature points, when there is a subsequent process for removing the feature points), the ratio of the keyframe image occupied by blur, the number of moving objects in the keyframe image, or the timing at which the keyframe information is generated.

The map extracting unit 111 may extract the keyframe information included in the map 120 by a certain ratio (predetermined ratio), prioritizing a piece having its keyframe position corrected by a smaller amount during the keyframe optimization process, or may extract a piece of keyframe information having the keyframe position corrected by an amount of at least a threshold. Furthermore, the map extracting unit 111 may also extract a certain ratio (predetermined ratio) of the keyframe information, by prioritizing a piece the keyframe image of which includes a larger amount of feature points; or may extract a piece the keyframe image of which is linked with feature points in the number of at least a threshold. Furthermore, the map extracting unit 111 may extract the keyframe information the keyframe image of which includes a blurred area of not more than a threshold. Furthermore, the map extracting unit 111 may extract the keyframe information the keyframe image of which includes the number of detected moving objects of not more than a certain number, or includes moving objects occupying an area of not more than a threshold. Furthermore, the map extracting unit 111 may extract a predetermined number of pieces (a predetermined ratio) of the keyframe information from the pieces created later in time.

Furthermore, the map extracting unit 111 may extract the keyframe information including a marker indicating a specific position. Furthermore, the map extracting unit 111 may extract the keyframe information from the map 120 on the basis of the direction in which the image capturing unit 204 in the controller 200 captures images. In order to prioritize extraction of the keyframe information in the direction in which the image capturing unit 204 is often directed, weights are given to the positive and negative directions of the three axis, in advance, for example. The directions in which the image capturing unit 204 is often directed are weighted more. The map extracting unit 111 may generate an extracted map 121 by extracting pieces of keyframe information in numbers proportional to the weights given to the respective directions, from such directions, respectively. The map extracting unit 111 may extract the keyframe information by combining a plurality of conditions selected from those described above.

The extracted map 121 is transmitted to the controller 200 a plurality of number of times, depending on the extraction method. The controller 200 may therefore be configured to delete the extracted maps 121 received in the past, sequentially from those that are older, depending on the storage capacity of the controller 200.

According to the first embodiment described above, by acquiring the position-orientation information of the controller 200 using the extracted map 121 generated in the HMD 100, the controller 200 can estimate the position-orientation of the controller 200 at a higher accuracy. Furthermore, because the extracted map 121 that is an extraction of a part of the map 120 is received from the HMD 100, even with the controller 200 having a processing capacity and a storage capacity smaller than those of the HMD 100, it is possible to estimate the position-orientation favorably.

Note that the first to the third extraction methods and the other extraction methods described above may be applied in a manner combined as appropriate. Furthermore, the HMD 100 may generate an extracted map 121 for each of a plurality of controllers 200, without limitation to one controller 200, and transmit the extracted maps 121 corresponding to the plurality of respective controllers 200 to such a plurality of controllers 200, respectively.

### Second Embodiment

In the first embodiment, the controller 200 receives the extracted map 121 from the HMD 100, and acquires the position-orientation information of the controller 200 on the basis of a captured image captured by the image capturing unit 204 and the received extracted map 121. By contrast, in a second embodiment, the controller 200 transmits the captured image captured by the image capturing unit 204 to the HMD 100, and causes the HMD 100 to acquire the position-orientation information of the controller 200.

A configuration of the HMD 100 according to the second embodiment is the same as that illustrated in FIG. 1A, but the process performed by the communicating unit 108 is different from that in the first embodiment. A configuration of the controller 200 according to the second embodiment is the same as that illustrated in FIG. 1B, but the processes performed by the communicating unit 208 and the position-orientation acquiring unit 209 are different from those in the first embodiment. The processes that are different from those in the first embodiment will now be explained.

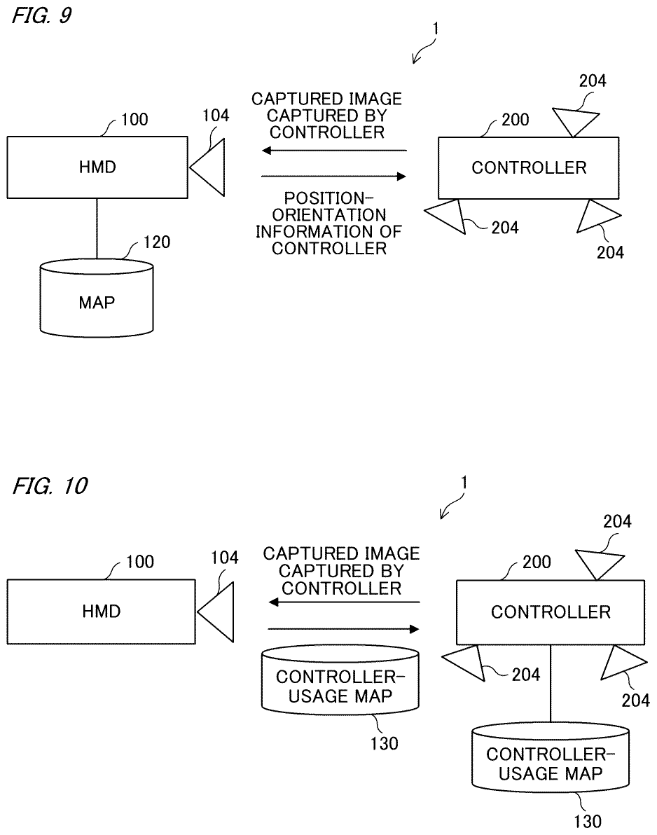

FIG. 9 is a schematic for explaining the information processing system according to the second embodiment. The communicating unit 208 in the controller 200 transmits a captured image captured by the image capturing unit 204 to the HMD 100. The HMD 100 acquires the position-orientation information of the controller 200, on the basis of the captured image captured by the image capturing unit 204 and received from the controller 200, and the map 120 generated by the map generating unit 110. The map 120 is a piece of map information generated on the basis of the position-orientation information of the HMD 100 and a keyframe image captured at the position-orientation, in the same manner as in the first embodiment. The communicating unit 108 in the HMD 100 transmits the acquired position-orientation information of the controller 200, to the controller 200.

The controller 200 transmits a captured image to the HMD 100 at a predetermined time interval, and receives position-orientation information of the controller 200, acquired by the HMD 100. The controller 200 may acquire the position-orientation information of the controller 200 using odometry during the period from when the position-orientation information of the controller 200 is received from the HMD 100, to when the captured image is transmitted to the HMD 100 next.

According to the second embodiment described above, because the controller 200 receives the position-orientation information of the controller 200 acquired by the HMD 100 using the map 120, it is possible to estimate the position-orientation of the controller 200 highly accurately. Furthermore, because the controller 200 does not perform the process of generating the map 120 and acquiring the position-orientation information of the controller 200, the processing load is alleviated. Furthermore, because the map information is not retained, a less storage capacity is required on the controller 200, compared with that according to the first embodiment.

### Third Embodiment

In the second embodiment, the controller 200 transmits a captured image captured by the image capturing unit 204 to the HMD 100, and causes the HMD 100 to acquire the position-orientation information of the controller 200. By contrast, in a third embodiment, the controller 200 transmits a captured image captured by the image capturing unit 204 to the HMD 100, and causes the HMD 100 to generate a map for the controller 200.

A configuration of the HMD 100 according to the third embodiment is the same as that illustrated in FIG. 1A, except the map extracting unit 111 is omitted, but the processes performed by the communicating unit 108, the position-orientation acquiring unit 109, and the map generating unit 110 are different from those in the first embodiment. A configuration of the controller 200 according to the third embodiment is the same as that illustrated in FIG. 1B, but the processes performed by the communicating unit 208 and the position-orientation acquiring unit 209 are different from those in the first embodiment. Such processes that are different from those in the first embodiment will now be explained.

FIG. 10 is a schematic for explaining the information processing system according to the third embodiment. The communicating unit 208 in the controller 200 transmits the captured image captured by the image capturing unit 204 to the HMD 100. The position-orientation acquiring unit 109 included in the HMD 100 acquires the position-orientation information of the controller 200, using the captured image received from the controller 200. The map generating unit 110 generates a controller-usage map 130 on the basis of the position-orientation information of the controller 200 and a keyframe image that is the captured image captured at that position-orientation. The communicating unit 108 transmits the generated controller-usage map 130 to the controller 200.

The controller 200 acquires the position-orientation information of the controller 200, using the captured image captured by the image capturing unit 204 and the controller-usage map 130 received from the HMD 100. By using the controller-usage map 130 generated by the HMD 100 having a greater processing capacity than that of the controller 200, the controller 200 can acquire the position-orientation information of the controller 200 accurately. The HMD 100 may generate the controller-usage map 130 using the captured images captured by the image capturing unit 204 received from the controller 200, and transmits the controller-usage map 130 to the controller 200 not in real-time.

Furthermore, the HMD 100 may generate a new controller-usage map 130 by combining the map 120 for the HMD 100, generated in the first embodiment, and the controller-usage map 130. The HMD 100 may generate a new controller-usage map 130 by extracting keyframe information the indices of which indicate qualities that satisfy a predetermined condition from the map 120, and combining the keyframe information with the controller-usage map 130, for example. Furthermore, the HMD 100 may integrate the map 120 and the controller-usage map 130, following a map integrating process using the known SLAM.

Furthermore, the position-orientation acquiring unit 109 included in the HMD 100 may also acquire the position-orientation information of the controller 200 by detecting the HMD 100 from the captured image received from the controller 200. Specifically, the HMD 100 acquires the position-orientation information of the HMD 100, using the map 120, and acquires a relative position-orientation of the controller 200 from the result of detecting the HMD 100 in the captured image received from the controller 200. The HMD 100 can acquire the position-orientation information of the controller 200 on the basis of the position-orientation of the HMD 100 and the relative position-orientation of the controller 200.

According to the third embodiment described above, because the controller 200 acquires the position-orientation information of the controller 200, using controller-usage map 130 generated by the HMD 100, it is possible to estimate the position-orientation of the controller 200 highly accurately.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The above-mentioned embodiments (including the variation) are only examples, and configurations obtained by deforming or changing the above-mentioned configuration as appropriate within a scope of the gist of the present invention are also included in the present invention. The configurations obtained by combining the above-mentioned configurations as appropriate are also included in the present invention.

According to the present invention, favorable position-orientation estimations can be achieved, on a terminal device having a limited processing capacity and storage capacity.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing system comprising a head-mounted display and a controller, and configured to estimate a position-orientation of the controller, wherein
the head-mounted display includes:
a first camera; and
one or more processors and/or circuitry configured to:
perform first acquiring processing to acquire position-orientation information of the head-mounted display by using a captured image captured by the first camera;
perform generating processing to generate map information based on the position-orientation information of the head-mounted display and a keyframe image that is a captured image captured at that position-orientation;
perform extracting processing to extract a part of the map information; and
perform communicating processing to transmit extracted map information extracted in the extracting processing to the controller, and
the controller includes:
a second camera; and
one or more processors and/or circuitry configured to perform second acquiring processing to acquire position-orientation information of the controller by using a captured image captured by the second camera and the extracted map information transmitted from the head-mounted display.

2. The information processing system according to claim 1, wherein, in the second acquiring processing, the position-orientation information of the controller is acquired by using a captured image captured by the second camera, and at a predetermined timing, the position-orientation information of the controller is acquired by using a captured image captured by the second camera and the extracted map information transmitted from the head-mounted display.

3. The information processing system according to claim 2, wherein the predetermined timing is a regular timing or a fixed timing.

4. The information processing system according to claim 1, wherein the map information includes a plurality of pieces of keyframe information each associating the position-orientation information of the head-mounted display and the keyframe image captured at that position-orientation.

5. The information processing system according to claim 4, wherein, in the extracting processing, the keyframe information having been created at a nearby area around the controller is extracted from the map information.

6. The information processing system according to claim 5, wherein a size of the nearby area is determined based on at least any of a processing capacity of the controller, a storage capacity of a storage portion included in the controller, and number of pieces of the keyframe information within the nearby area.

7. The information processing system according to claim 4, wherein, in the extracting processing, an area, where positions at which keyframe images are captured are distributed, is divided into a plurality of split areas, and a representative piece of the keyframe information is extracted from each of the split areas.

8. The information processing system according to claim 7, wherein, in the extracting processing, number of the split areas or a size of the split areas is changed based on a size of the area, where positions at which the keyframe images are captured are distributed.

9. The information processing system according to claim 7, wherein, in the communicating processing, the extracted map information is transmitted to the controller in a case where number of the split areas or a size of the split areas is changed.

10. The information processing system according to claim 4, wherein, in the extracting processing, the keyframe information is extracted based on variance in positions of a feature point captured in the keyframe image or a reprojection error of the feature point.

11. The information processing system according to claim 4, wherein, in the extracting processing, the keyframe information is extracted from the map information, based on a ratio by which the keyframe image is occupied by blur, number of moving objects included in the keyframe image, or timing at which the keyframe information is generated.

12. The information processing system according to claim 4, wherein, in the extracting processing, the keyframe information is extracted from the map information, based on a direction in which the controller captures an image.

13. The information processing system according to claim 1, wherein
the controller further includes an inertial measurement unit, and
in the second acquiring processing, the position-orientation information of the controller is acquired by using the inertial measurement unit, and at a predetermined timing, the position-orientation information of the controller is acquired by using a captured image captured by the second camera and the extracted map information transmitted from the head-mounted display.

14. The information processing system according to claim 1, wherein, in the extracting processing, an amount to be extracted or a ratio to be extracted from the map information is changed based on at least any of a processing capacity and a storage capacity of the controller.

15. The information processing system according to claim 1, wherein, in the extracting processing, an amount to be extracted or a ratio to be extracted from the map information is changed based on a speed of movement of the controller or an acquisition condition of the position-orientation information of the controller.

16. The information processing system according to claim 1, wherein
in the extracting processing, pieces of the extracted map information are generated for a plurality of the controllers respectively, and
in the communicating processing, the pieces of the extracted map information are transmitted to the plurality of the controllers respectively.

17. A head-mounted display generating map information for allowing a controller to estimate a position-orientation, the head-mounted display comprising:
a camera; and
one or more processors and/or circuitry configured to:
perform acquiring processing to acquire position-orientation information of the head-mounted display by using a captured image captured by the camera;
perform generating processing to generate the map information based on the position-orientation information of the head-mounted display and a keyframe image that is a captured image captured at that position-orientation;
perform extracting processing to generate extracted map information to be used in acquiring orientation information of the controller by extracting a part of the map information; and
perform communicating processing to transmit the extracted map information to the controller.

18. A controller estimating a position-orientation using map information received from a head-mounted display, the controller comprising:
a camera; and
one or more processors and/or circuitry configured to:
perform communicating processing to receive, from the head-mounted display, extracted map information resultant of extracting a part of the map information generated based on position-orientation information of the head-mounted display and a keyframe image that is a captured image captured at that position-orientation; and
perform acquiring processing to acquire position-orientation information of the controller by using a captured image captured by the camera and the extracted map information transmitted from the head-mounted display.

19. A method of controlling an information processing system including a head-mounted display and a controller, and configured to estimate a position-orientation of the controller, the method comprising:
a first acquiring step of acquiring position-orientation information of the head-mounted display by using a captured image captured by a first camera of the head-mounted display;
a generating step of generating map information based on the position-orientation information of the head-mounted display and a keyframe image that is a captured image captured at that position-orientation;
an extracting step of extracting a part of the map information;
a communicating step of transmitting extracted map information extracted in the extracting step to the controller; and
a second acquiring step of acquiring position-orientation information of the controller by using a captured image captured by a second camera of the controller and the extracted map information transmitted from the head-mounted display.
